(19) United States
(12) Patent Application Publication
(10) Pub. No.: US 2009/0040201 A1
(43) Pub. Date: Feb. 12, 2009

(54) DEVICE AND METHOD FOR DRIVING ELECTROPHORETIC DISPLAY TO DESIRED OPTICAL STATE

(76) Inventors: Joo-Young KIM, Suwon-si (KR); Cheol-Woo Park, Suwon-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/039,117

(22) Filed: Feb. 28, 2008

(30) Foreign Application Priority Data
Aug. 6, 2007 (KR) 10-2007-0078403

(51) Int. Cl. G09G 5/00; G09G 3/34

(52) U.S. Cl. 345/204; 345/107

(57) ABSTRACT

A drive controller for an electrophoretic display includes a data driver for applying image-altering drive signals to selected ones of a plurality of pixels where the driver includes: a memory unit for storing an alteration progress indicator and a target state indicator. In each of predetermined time spans such as successive display frames, image-altering drive signals are applied and the corresponding progress indicators are updated to reflect the application of the image-altering drive signals in the predetermined time spans. When the progress indicators indicate that the image-altering jobs are finished, the driver stops applying the image-altering drive signals to the respective pixels and instead applies a compensating signal to recover their original optical states. Different pixels can be updated in time-overlapping manner so that the electrophoretic display responds to new image commands in real-time.

### CROSS-REFERENCE TO RELATED APPLICATION

This application claims priority to and the benefit of Korean Patent Application No. 10-2007-0078403 filed in the Korean Intellectual Property Office on Aug. 6, 2007, the entire disclosure of which is incorporated herein by reference.

### BACKGROUND

(a) Field of Invention

The present disclosure of invention relates to a device and a method for driving an electrophoretic display.

(b) Description of Related Technology

Recently, electrophoretic displays (EPD's) are being developed as flat panel display devices of similar form factor to that of flat panel liquid crystal displays (LCDs).

The conventional electrophoretic display includes an electrophoretic panel assembly including a matrix of pixel units where each pixel unit includes an electrically activated switch (e.g., thin film transistor or TFT) coupled to a pixel electrode where the latter electrode defines part of an electrophoretic capacitor. The electrophoretic panel assembly further includes a plurality of display signal lines, a gate driver for providing a scanning signal having a gate-on voltage level (V_{gON}) and a gate-off voltage level (V_{gOFF}) to a gate line from among the display signal lines and for thereby turning on/off the switch of each pixel unit driven by the scanning signal. The electrophoretic panel assembly further includes a data driver for providing an analog data voltage to a data line from among the display signal lines and providing the same to respective pixel electrodes of pixel units through the turned on switches of such pixel units, and a signal controller for controlling the gate driver and the data driver.

In addition to the pixel electrode, the electrophoretic capacitor includes as a further plate thereof, a portion of a common electrode and an electrophoretic material layer interposed between the two opposed capacitor plates where the electrophoretic material layer includes electrophoretic particles provided in a dielectric fluid between the two plates and functions as a dielectric material. When a common voltage, which is a reference voltage, is applied to the common electrode, and a data voltage (positive or negative) is applied to the pixel electrode, an electric field corresponding to a difference between the two voltages develops across the electrophoretic material layer and as a result, the electrophoretic particles having positive or negative charges move between the two electrodes according to the direction and strength of the electric field, where the moving distance can be controlled by controlling a pixel voltage applying time. When the pixel voltage levels and applying times for respective pixels are appropriately controlled and the relative positions of the electrophoretic particles in each pixel unit are kept track of, then images with various gray levels or color intensities may be displayed.

When an image display voltage corresponding to a desired strength and direction of electric field is continuously applied through the data driver so as to cause the electrophoretic particles to move towards the displaying of a corresponding image, then over time excessive net charges may accumulate on both electrodes of the electrophoretic capacitor of each pixel unit so as to thereby generate an undesirable after-image. Accordingly continuous application of, for example; a positive drive voltage to the pixel units can cause the display performance of the electrophoretic display to become deteriorated. In one class of displays, in order to prevent the above-noted problem, the accumulation of net charge on the plates (pixel electrodes) is neutralized by causing the voltage across each electrophoretic capacitor to return to zero each time after the electrophoretic particles have been moved, the desired image has been formed and preparation is needed for creating a new different image. This is done by applying an image display compensating voltage that is equal to the applied pixel voltage but has an opposite polarity to that of the image-forming pixel voltage after the image-forming pixel voltage has been applied for a predetermined time, thus causing the electrophoretic capacitor to return to the zero voltage state after the electrophoretic particles have been moved a certain distance over the predetermined drive application time (e.g., a drive time of one horizontal scan period or 1H) and the desired image had been displayed. That is, the displaying of an image by the electrophoretic display is performed by repeatedly applying the image-forming display voltage (e.g., a positive voltage) over the course of plural frames and thereby displaying the image. After the image has been formed and displayed over the course of a first sequence of frames, the plate is wiped clean (the electrophoretic capacitor is neutralized back to the zero voltage state) by applying the image display compensation voltage of opposed polarity over a same number of frames.

However, if the image-forming display voltage and the compensation voltage are alternately applied sequentially in this way for each glyph (e.g., each graphic icon) and if the system waits for each glyph (e.g., the letter “A” or another to-be-displayed symbol) to acquire a desired state before adjusting the state of a next glyph (e.g., the letter “B” or another to-be-displayed symbol), then the speed of displaying moving images becomes substantially slowed or the amount of power consumed by the system tends to be disadvantageously increased depending on how the problem is handled. Particularly, in the case of receiving information that is updated on a real-time basis from an external information input device, if the real-time image-forming display voltage does not begin to be updated immediately for each pixel (or other display area) because the display unit is busy updating just one pixel (or just one glyph or another display area) at a time before switching to a state that begins the updating of the next to be updated pixel/glyph area, then the image display speed cannot be improved or lowering of power consumption is not possible (because for the latter case more power is used to speed the processing time for each pixel).

The above information disclosed in this Technology Background section is only for enhancement of understanding of the present disclosure and therefore it may contain information that does not form part of the prior art that is already known to persons of ordinary skill in the art.

### SUMMARY

In accordance with the present disclosure, the start of updating of pixels (or other display areas) of an electrophoretic display is started almost immediately and carried out on a time overlapping basis so that updating of next pixel is not delayed by already-in-progress updating of a first pixel. In other words, the updating of a second pixel or second display area may begin even before the updating of a first pixel or first display area is completed. This allows for an improvement in image update speed for the electrophoretic display or in a reducing of power consumption due to updating in real-time of the display information.

According to one aspect of the present disclosure, a drive controller for an electrophoretic display includes a data driver unit for applying image-forming data signals to a plurality of pixels which contain electrophoretic particles. The drive controller further includes: a first memory unit for storing target state values representing final optical states to which respective pixels (e.g., pixels A, B and C) or display areas are to be driven over a time span of one or more fram drive controller es and a second memory unit for storing progress count-down values indicative of the current progress in achieving the desired final optical states for each of the respective pixels (e.g., pixels A, B and C) or display areas. The drive controller further includes a count-down generator for defining and storing the respective count-down value for each respective pixel in the second memory unit; a counter for synchronously counting-down and saving the updated count-down value; and a circuit for applying the compensating voltage to return back the charges of a respective pixel (or other display area) when the updated count-down value indicates the transition to the targeted optical state is finished.

In accordance with a method of the disclosure, the signal controller reads the initial input image signal information or the updated input image signal information stored in the second memory to output an output image signal to the data driver, stores input image signal information updated through counting in the second memory, and when the update on the input image signal information stored in the second memory is finished, reads the initial input image signal stored in the first memory to output an output image compensation signal to the data driver.

In one embodiment, the input image signal information is luminance information to be displayed by the plurality of pixels, and it is further information on a time for applying or a number of times that a pixel voltage is to be applied for driving the electrophoretic particles to a desired display state.

The signal controller further includes a counter for performing counting so as to update the initial input image signal information or the updated input image signal information stored in the second memory.

In one embodiment, the counting is performed periodically such as once per frame.

In one embodiment, the time for applying the pixel drive voltage is 1 horizontal period per frame, and the input image signal information updated through counting is information on the time for applying the pixel voltage that is reduced by the 1 horizontal period before performing the counting.

In one embodiment, the electrophoretic particles include first electrophoretic particles and second electrophoretic particles having opposite electrical charges.

In another aspect of the present disclosure, a method for driving an electrophoretic display comprising a data driver for applying an image data signal to a plurality of pixels to which electrophoretic particles are provided includes: storing initial input image signal information or input image signal information that is updated through counting performed for a predetermined time into a memory unit; outputting an output image signal to the data driver according to the initial input image signal information or the updated input image signal information stored in the memory unit, and storing the input image signal information updated through counting into the memory unit; and applying an output image compensation signal to the data driver according to the initial input image signal information stored in the memory unit when the update on the input image signal information stored in the memory unit is finished.

In the step of storing the initial input image signal information or the input image signal information updated through counting for each predetermined time into a memory unit, the memory unit includes a first memory for storing the initial input image signal information and a second memory for storing the initial input image signal information or the updated input image signal information.

In the step of outputting an output image signal to the data driver according to the initial input image signal information or the updated input image signal information stored in the memory unit and storing the input image signal information updated through counting into the memory unit, an output image signal is output to the data driver based on the initial input image signal information or the updated input image signal information stored in the second memory, and the input image signal information updated through counting is stored in the second memory.

In one embodiment, the input image signal information is luminance information displayed by the plurality of pixels and it is also information on the time for applying a pixel voltage applied so as to drive the electrophoretic particles.

In one embodiment, the counting is performed once per frame.

In one embodiment, the time for applying the pixel voltage is the 1 horizontal period per frame, and the input image signal information updated through the counting is information on the time for applying the pixel voltage that is reduced by the 1 horizontal period before performing the counting.

The electrophoretic particles generally include first electrophoretic particles and second electrophoretic particles having opposite electric polarities.

Before the step of storing initial input image signal information or input image signal information that is updated through counting performed for a predetermined time into a memory unit, applying a reset image signal to the data driver; and applying a reset image compensation signal to the data driver.

### BRIEF DESCRIPTION OF THE DRAWINGS

FIG. 1 is a block diagram of an electrophoretic display according to an exemplary embodiment.

FIG. 2 is an equivalent circuit diagram for a pixel in an electrophoretic display according to an exemplary embodiment.

FIG. 3 is a cross-sectional view of a pixel in an electrophoretic display of FIG. 2.

FIG. 4 shows input image signal information stored per frame into a memory unit of a drive controller in an electrophoretic display according to an exemplary embodiment.

FIG. 5 shows a data voltage applied to predetermined pixels through a data driver according to the input image signal information stored per frame into a memory unit of FIG. 4.

FIG. 6 shows a position change of electrophoretic particles positioned at one of the predetermined pixels according to application of a data voltage of FIG. 5.

FIG. 7 shows images that are displayed per frame according to the predetermined pixels according to application of a data voltage of FIG. 5.

### DETAILED DESCRIPTION

The present disclosure of invention will be described more fully hereinafter with reference to the accompanying drawings, in which exemplary embodiments are shown.

In the drawings, the thickness of layers, films, panels, regions, etc., may be exaggerated for clarity. Like reference numerals generally designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

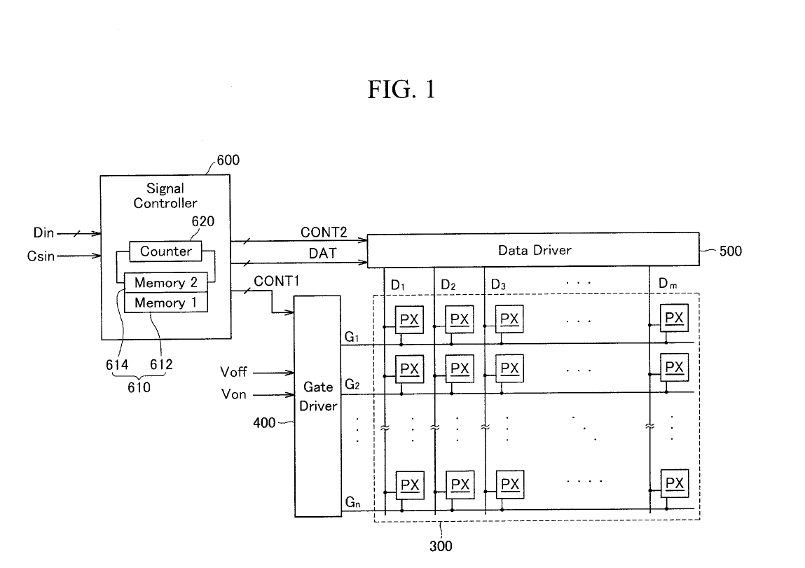

Referring to FIG. 1 to FIG. 3, an electrophoretic display according to an exemplary embodiment will be described.

As shown in FIG. 1, the electrophoretic display includes an electrophoretic panel assembly 300, a gate driver 400, a data driver 500, and a signal controller 600.

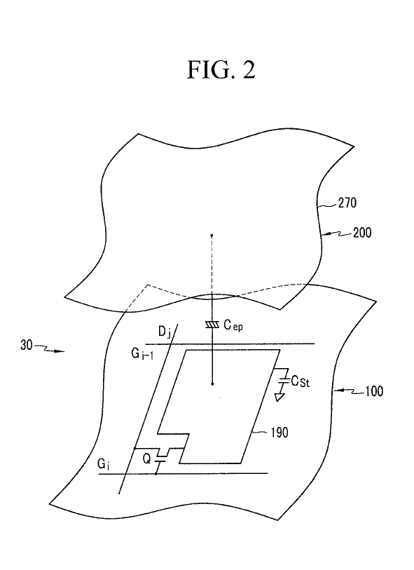

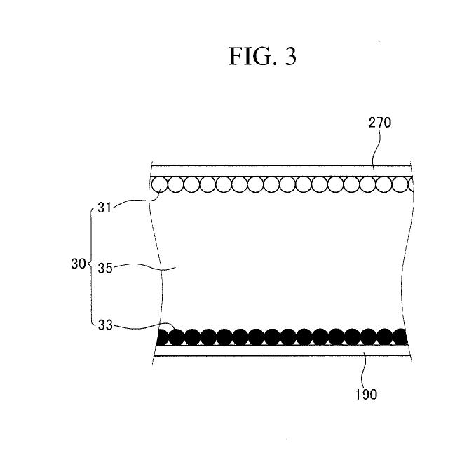

As shown in FIG. 1 and FIG. 2, the electrophoretic panel assembly 300, shown as an equivalent circuit, includes a plurality of signal lines (G₁-Gₙ, D₁-Dₘ) and a plurality of pixels PX coupled thereto and arranged in the matrix format. Referring to the structure shown in FIG. 3, the pixel PX of the electrophoretic panel assembly 300 includes a pixel electrode 190 and a common electrode area 270 facing each other, and an electrophoretic material layer 30 provided therebetween.

The signal lines (G₁-Gₙ, D₁-Dₘ) include a plurality of gate lines (G₁-Gₙ) for transmitting a gate signal (or a scanning signal) and a plurality of data lines (D₁-Dₘ) for transmitting a data voltage. The gate lines (G₁-Gₙ) are arranged in the row direction and in parallel, and the data lines (D₁-Dₘ) are arranged in the column direction and in parallel.

As shown in FIG. 2, for example, the pixel PX coupled to the i-th (i=1, 2, . . . , n) gate line (Gᵢ) and the j-th (j=1, 2, . . . , m) data line (Dⱼ) includes a switch Q coupled to the signal lines (Gᵢ, Dⱼ), an electrophoretic capacitor (Cep) coupled thereto, and a storage capacitor Cst. If desired, the storage capacitor Cst can be omitted.

In one class of embodiments, the switch Q is a three terminal electronic element, such as a thin film transistor (TFT), where the switch Q is installed on the lower panel 100, and has a control terminal coupled to the gate line (Gⱼ), an input terminal (source) coupled to the data line (Dⱼ), and an output terminal (drain) coupled to the electrophoretic capacitor (Cep) and to the storage capacitor Cst.

The electrophoretic capacitor (Cep) has a pixel electrode 190 formed on the lower panel 100 and a common electrode portion 270 defined on the upper panel 200 as two terminals, and an electrophoretic material layer 30 disposed between the two electrodes 190 and 270 to function as a dielectric material. The pixel electrode 190 is coupled to the switch Q, and the common electrode 270 is formed on the front of the upper panel 200 and receives a common voltage Vcom.

In one embodiment, the electrophoretic layer 30 includes white electrophoretic particles 31 electrified with a selected one of negative charges (−) and positive charges (+), black electrophoretic particles 33 electrified with charges of the opposite polarity, and a transparent dielectric fluid 35 through which the electrophoretic particles 31 and 33 can move when a motive electric field of appropriate strength and direction is formed through the structure. The electrophoretic layer 30 can further include micro-capsules for confining respective ones or more of the electrophoretic particles 31 and 33 and the transparent dielectric fluid 35.

The storage capacitor Cst for performing a supplementary charge storage function of the electrophoretic capacitor (Cep) is formed by superimposing an additional signal line (not shown) provided on the lower panel 100 and the pixel electrode 190 with an insulator therebetween, and a predetermined voltage such as the common voltage Vcom is applied to the additional signal line. However, the storage capacitor Cst can be formed by superimposing the pixel electrode 190 and the previous gate line (Gᵢ₋₁) with the insulator as a medium. The storage capacitor Cst can be omitted.

The gate driver 400 is coupled to the gate lines (G₁-Gₙ) and applies a gate signal that is a combination of the gate-on voltage Von and the gate-off voltage Voff applied to the gate lines (G₁-Gₙ) at different times (e.g., during horizontal row scanning periods, H).

The data driver 500 is coupled to the data lines (D₁-Dₘ) of the electrophoretic panel assembly 300, and applies an analog data voltage corresponding to a supplied digital image data signal to the data lines (D₁-Dₘ).

The signal controller 600 controls the gate driver 400 and the data driver 500, and includes a memory unit 610 and a progress-updating counter 620.

The memory unit 610 includes a first memory 612 and a second memory 614.

In accordance with the disclosure, the first memory 612 stores target image state information corresponding to a target optical state that is to be achieved in conformance with an image signal that is provided by an external image data supplying device (not shown). The second memory 614 stores updatable progress information indicating where along the path or transition to achieving the targeted optical state the system is. In one embodiment, the progress information is updated once for each frame. In one embodiment, the target image state information (612) and the updated progress-of-transition information (614) respectively define a luminance level to be achieved by one or a plurality of pixels PX, and a length of time (expressed in number of frames) for applying a pixel-driving voltage to the tracked pixels (PX) so as to thereby change positions of electrophoretic particles 31 and 33 in the tracked pixels (PX) from an initial first optical state (e.g., displaying white) to a different second optical state (e.g., displaying dark gray or black). Here, the time for applying the pixel-driving voltage during a frame corresponds to 1 horizontal period (1H) within the frame and the total time for applying the pixel-driving voltage in order to achieve the desired new optical state is expressed as a whole number of frames (e.g., 4frames to achieve switchover of the given pixel from an all-white optical state to an all-black optical state).

The counter 620 performs a progress count-down function for each frame by reducing a currently stored progress count (614) by one at the end of each frame during which the drive voltage was applied until the count hits zero (0), at which point application of the drive voltage is halted. Thus the progress tracking information that is updated through the down-counting function of the counter 620 is information indicating the length of further time to be consumed in applying the pixel-driving voltage to the pixels whose optical state(s) is/are to be changed by the pixel-driving voltage. The progress tracking number is reduced by 1 at the end of each horizontal period (1H) for which the pixel-driving voltage is applied to the tracked pixel(s) (PX). When the progress tracking number reaches zero (0) this indicates there are no further horizontal periods needed for driving the tracked pixel(s) (PX) to their targeted optical states and application of the pixel-driving voltage is therefore to be halted.

The first memory 612 (desired target state) and the second memory 614 (progress count) can be realized as separate devices, or they can be different storage spaces provided in a single storage device.

The signal controller 600 receives an input image signal from an external source indicating the optical state to be achieved and in response the signal controller 600 stores a corresponding target value in a corresponding location of the first memory 612 (target state). This target value (612) is also output as a corresponding output image signal (DAT) to the data driver 500. At the same time, the signal controller 600 calculates the number of frames over which the corresponding output image signal (DAT) is to be applied to the corresponding pixels (PX) and this length-of-time indicator is stored as a count-down value in the second memory 614. Also, after each period (e.g., 1H) of application of the corresponding output image signal (DAT), the signal controller 600 updates the count-down value stored in the second memory 614, and when the count-down value stored in the second memory 614 reaches zero; meaning that the desired transition to the new optical state is finished, the signal controller 600 responsively halts application of the corresponding output image signal (DAT) to the corresponding pixel(s) by, for example, outputting a zero voltage output signal to the data driver 500.

An image display operation by the electrophoretic display will now be described.

The signal controller 600 receives in real-time an input image digital signal (Din) and an input control digital signal (CSin) for controlling display of the input image signal from an external graphic controller (not shown) or an external input device (not shown). Examples of the input control signal are a vertical synchronization signal, a horizontal synchronizing signal, a main clock signal, and a data enable signal.

The signal controller 600 processes the input image digital signal (Din) according to the operating condition of the electrophoretic panel assembly 300 and based on the input image signal (Din) and the input control signal (CSin), generates a gate control signal CONT1 and a data control signal CONT2. The signal controller 600 transmits the gate control signal CONT1 to the gate driver 400, and transmits the data control signal CONT2 and the processed output image signal DAT to the data driver 500.

The gate control signal CONT1 includes a scanning start signal STV for instructing the scanning signal's scan start and at least one clock signal (CLK) for controlling the scanning signal's output. The gate control signal CONT1 can further include an output enable signal OE for controlling the maintenance time of the gate on voltage Von.

The data control signal CONT2 includes a horizontal synchronization start signal STH for indicating data transmission of one pixel row, a load signal LOAD for loading the corresponding analog data voltage to the data lines (D₁-Dₘ), and a data clock signal HCLK.

The data driver 500 receives an output image signal DAT on the pixels PX of one row according to the data control signal CONT2 provided by the signal controller 600, converts the output image digital signal DAT into the corresponding analog data voltage, and applies the data voltage to the corresponding data lines (D₁-Dₘ) during the horizontal scan period (1H) of the respective display row.

The gate driver 400 applies the scanning signal to the gate lines (G₁-Gₙ) according to the gate control signal CONT1 provided by the signal controller 600 to turn on the switch Q coupled to the gate lines (G₁-Gₙ), and hence causes the data voltage to be applied to the data lines (D₁-Dₘ) to the corresponding pixels PX through the turned on switches Q of the active display row.

The difference between the data voltage applied to the pixel-electrode of the pixel PX and the common voltage Vcom defines a charging or drive voltage for the electrophoretic capacitor (Cep), that is, the pixel voltage. The electrophoretic particles 31 and 33 can be moved to various positions between the pixel electrode 190 and the common electrode 270 according to the pixel voltage's strength, polarity, and duration of application time. Two voltages having the same strength and opposite polarities are used for the pixel voltages in one embodiment of the present disclosure. The duration of application of one of these voltages determines how far the electrophoretic particles 31 and 33 will move towards a corresponding one optical state (e.g., all white) or towards the other state (e.g., all black).

For example, as shown in FIG. 3, when the white electrophoretic particles 31 are positioned near the common electrode 270, the electrophoretic display displays an image with a gray level (target value=0) that corresponds to all white. When the black color electrophoretic particles 33 are moved to instead be positioned near the common electrode 270, the electrophoretic display displays an image with a gray level (target value=4) that corresponds to dark black. Also, when the white and black electrophoretic particles 31 and 33 are positioned in various other states between the pixel electrode 190 and the common electrode 270, the electrophoretic display displays various images with gray levels that correspond to optical states (target values=1 to 3) between those of full white (target value=0) and full black (target value=4).

The gate-on voltage, Von is sequentially applied to all the gate lines (G1-Gn) one at a time to thus apply the pixel voltage to all the pixels PX and display the image of one frame by repeating the above-noted process for each 1 horizontal period (which is also called 1H and corresponds to one period of the horizontal synchronizing signal Hsync and the data enable signal DE).

Generally, as shown in FIG. 3, regarding the white electrophoretic particles 31 and the black electrophoretic particles 33 positioned at the common electrode 270 and the pixel electrode 190 of a predetermined pixel PX, the white electrophoretic particles 31 progressively move toward the pixel electrode 190 and the black electrophoretic particles 33 progressively move toward the common electrode 270 when a predetermined pixel-drive voltage is applied during 1 horizontal period of one frame. It is generally required to apply a predetermined pixel voltage pulse having a period corresponding to 1 horizontal line scan period over a plurality of frames in order to get the white electrophoretic particles 31 and the black electrophoretic particles 33 to completely exchange positions with one having moved all the way to the pixel electrode 190 and the other having moved all the way to the common electrode 270. It will be assumed in the exemplary embodiment that a predetermined pixel-drive voltage pulse applied during the horizontal periods requires a total of 4frames, that is, 4 horizontal scan periods of application, in order to perform such a complete swap of positions by the electrophoretic particles.

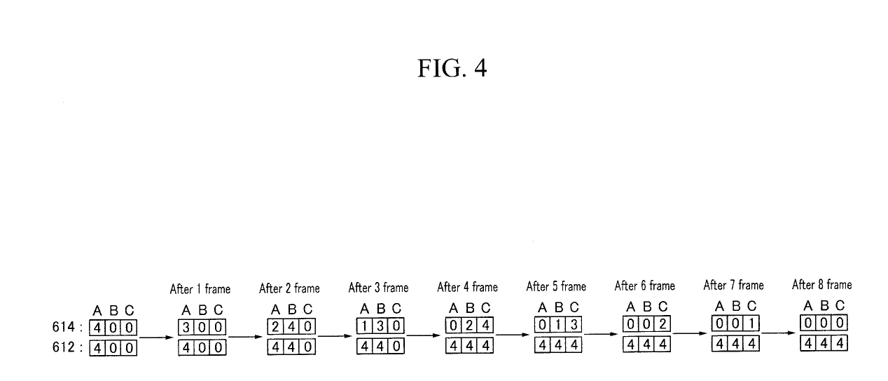

A method for driving a display device according to an exemplary embodiment of the present invention will now be described with reference to FIG. 4 to FIG. 7.

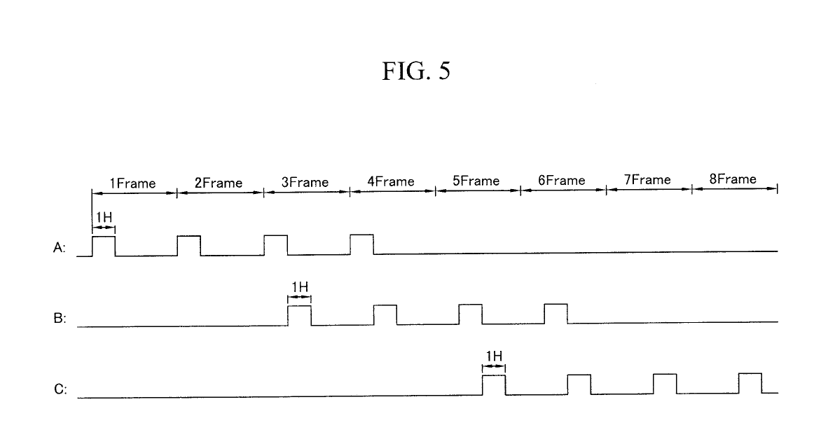

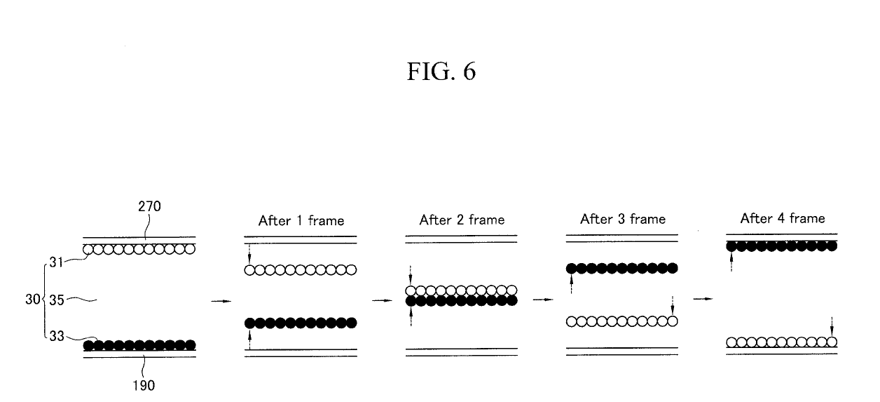

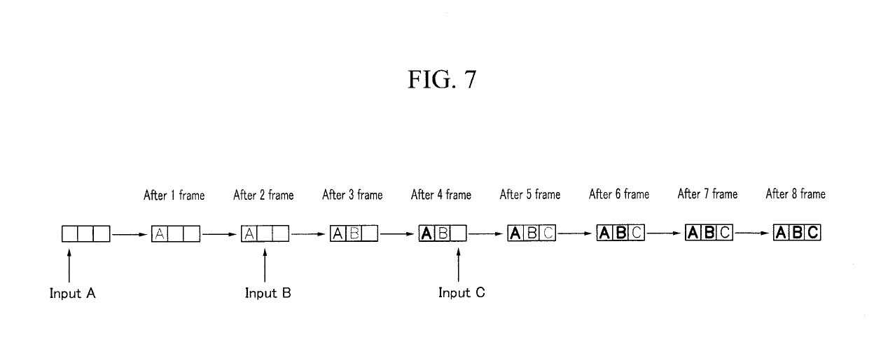

FIG. 4 shows the progression of image control information being stored per frame into a memory unit (610) of a drive controller in an electrophoretic display according to an exemplary embodiment of the present disclosure, FIG. 5 shows three plots, each of voltage versus time for showing how pixel-drive voltage pulses are applied in time overlapping manner to predetermined pixels (groups A, B and C) by way of a data driver and according to control information stored per frame into the memory unit 610 of FIG. 4. FIG. 6 shows the progression of position changes over time of electrophoretic particles disposed within one of the predetermined pixels (A, B or C) according to application of the data voltage pulses of FIG. 5. FIG. 7 shows how progressively darkening images are displayed per frame according to the predetermined pixels according to application of the data voltage pulses of FIG. 5.

It will be assumed for sake of example that the white electrophoretic particles 31 are electrified with negative charges (−), and the black electrophoretic particles 33 are electrified with positive charges (+). Also, it will be assumed that the predetermined pixel-drive voltage pulse that will be applied per frame is a positive one that needs to be applied to the pixel-electrode 190 for an effective application time of 4 horizontal scan periods and over a succession of 4 display frames in order for the white electrophoretic particles 31 and the black electrophoretic particles 33 to respectively move fully from adjacency to one of the pixel electrode 190 and the common electrode 270 to adjacency to the other one thereof. The A, B, and C display areas of FIG. 7 are areas in which a plurality of pixels are collected to form the desired A, B and C glyphs. The pixel areas will be assumed to be able to display the images of five gray levels from a zeroth gray image level (target level=0) that is fully white to a fourth gray image level (target level=4) that is fully black.

When the signal controller 600 is first powered up, it applies a reset image signal to the data driver 500, the data driver 500 applies a positive pixel-drive voltage to all the pixels PX. Here, the time for applying the positive pixel-drive voltage is 4 horizontal periods during a succession of 4 display-initializing frames. Accordingly, all the white electrophoretic particles 31 (negative) in the display panel move to be arranged proximate to the lower pixel electrode 190 (positive), and all the black electrophoretic particles 33 (positively charged) in the display panel move to be arranged proximate to the upper and transparent common electrode 270 (which corresponds to the arranged state after the 4 frames are passed, as shown in FIG. 6). Therefore, all the pixels PX display the fourth gray image level at this step of reset operation, namely, all black.

Next during the display reset compensating process, the signal controller 600 causes the data driver 500 to apply a negative pixel-drive voltage of same amplitude to all the pixel-electrodes 190 of all the pixels PX. Here, the time for applying the negative pixel voltage is again 4 horizontal periods distributed across a corresponding succession of 4frames. Accordingly, as seen by reading FIG. 6 in a right to left direction rather than the normal left to right, the white electrophoretic particles 31 (negatively charged) move away from the negatively driven and bottom pixel electrode 190 and back towards the upper common electrode 270. Similarly, the black electrophoretic particles 33 (positively charged) move toward the negatively driven pixel electrode 190. Therefore, at this second stage of the reset compensating operation all the pixels PX in the display panel will display the zeroth gray image level, namely all white.

Application of the positive pixel-drive voltage during the first part of the reset operation and application of the negative pixel-drive voltage during the second half leaves essentially no net charges stored between the electrodes 190 and 270, and all the pixels PX display the zeroth gray image level that is white. Thereafter, a selected subset of the pixels may be selectively driven toward a nonzero gray level state, and hence, glyphs or images such as characters or pictures having or composed of different grays are displayable.

Next, after the display reset compensating operation, the signal controller 600 receives an image display signal that is updated in real-time and the signal controller 600 sends corresponding control signals to the data driver 500 for each frame, which will now be described in detail.

Assume that a first time point the signal controller 600 receives a first image modifying signal that commands the displaying of the character “A” with the fourth gray level (target level=4) in an area containing a first group of pixels referred to here as the A display area and pointed to by the timing mark denoted as “Input A” in FIG. 7. In accordance with the disclosure, the signal controller 600 stores the target optical state (target=4) into a corresponding location of the first memory 612 associated with the to-be-transitioned pixels of the A display area at the time point denoted as “Input A” in FIG. 7. The signal controller 600 also stores the count of frames needed for achieving the desired target optical state as a count-down value (in this case also equal to 4) into a corresponding location of the second memory 614 associated with the to-be-transitioned pixels of the A display area during the same time point denoted as “Input A” in FIG. 7. This first recordation of target and count-down data is represented in FIG. 4 by the frame “0” entries of 614: [400] and 612: [400] for respective display areas A, B and C where the top or second memory 614 stores the current count-down value and the bottom or first memory 612 of the memory unit 610 stores the to-be-achieved target state.

That is, in the zeroth frame, when the instructing signal is received to form a gray level 4 glyph, “A”, the A display area information storage space of the first memory 612 and the second memory 614 of FIG. 4 respectively store the desired end state (target=4) and the transition count of 4 horizontal periods, which is the total time for applying the positive pixel-drive voltage pulse to attain the target gray state having the gray state value of 4 in this exemplary embodiment. At the same time because no change has yet been requested at the time of the “Input A” timing mark in FIG. 7 for the B and/or the C display areas to be changed, their target optical states (which are the same as their current optical states) are recorded as 00 (in section 612) and their current count-down values for reaching their targeted optical states are also recorded as 00 (in section 614).

Next, at the start of frame 1, the signal controller 600 reads the initial count-down values of [400] stored in the second memory 614 for respective display areas A, B and C. Since the count-down for the A display area stores a non-zero value representing 4 horizontal periods, during the first frame (denoted as 1Frame in FIG. 5), the signal controller 600 applies an output control signal to the data driver 500 so that the data driver 500 will apply a first positive pixel-drive voltage pulse to the corresponding pixel(s) PX of the A display area that define the “A” glyph during 1 horizontal period (1H) of the first frame, as shown in FIG. 5. The signal controller 600 then causes a neutral or zero drive voltage to be created across the electrophoretic capacitor for the remainder of the first frame (the 1Frame of FIG. 5). In this first instance, as soon as the first frame (the 1Frame) completes, the counter 620 fetches the count-down value of 4 stored in memory 614, decrements it and stores the updated value representing 3 remaining horizontal periods into the A display area of the second memory 614, as shown in FIG. 4. Due to the application of the drive-voltage for 1 horizontal scan period (1H), the electrophoretic particles 31 and 33 of the corresponding pixel PX will have moved as shown in the second picture from the left of FIG. 6 after the first frame is passed, and the A display area will be displaying the character A at a faint gray level that corresponds to the first gray level (light gray) as seen in FIG. 7 in the first frame that follows the “Input A” frame.

Since the B and C display control areas of memory 614 (FIG. 4) store the progress count-down value of 0 horizontal periods at this time, this indicates to the signal controller 600 that no state-changing voltage pulses are to be applied, and accordingly the data driver 500 does not apply the positive pixel-drive voltage pulse to the corresponding pixel(s) PX of areas B or C during the 1Frame horizontal period of FIG. 5. In the instance of areas B and C, the counter 620 performs no counting-down since the progress count-down value of 0 in each indicates that the B and C display areas are not to be updated. Accordingly, the electrophoretic particles 31 and 33 of the corresponding pixels PX of the B and C display areas after the first frame keep the same positions as shown in the first picture of FIG. 6, and the B and C display areas consecutively display the all white image that corresponds to the zeroth gray level as seen in FIG. 7 in the first frame that follows the “Input A” frame.

After the first frame and before the second frame (the 2Frame of FIG. 5), the signal controller 600 reads the updated count-down values stored in the second memory 614. Since the A display area information storage space stores the value representing 3 more horizontal periods of drive application being needed to reach the target state indicated in memory 612, the signal controller 600 causes the data driver 500 to apply the predetermined positive pixel-drive voltage pulse to the corresponding pixel(s) PX in the A display area during the corresponding 1 horizontal period of the second frame (the 2Frame of FIG. 5). In this instance, the counter 620 again decrements the progress count-down value and stores a value representing 2 horizontal periods back into the A display area of the second memory 614, as shown in FIG. 4. The electrophoretic particles 31 and 33 of the corresponding pixel(s) PX will now have moved as shown in the third picture of FIG. 6 after the second frame because of application of the positive pixel voltage during the 1 horizontal period of the second frame, and the A display area will therefore display the further darkened character A that corresponds to the second gray level.

The values stored in the B and C display area information storage spaces are not yet changed as described above (because for one reason, no Input-B or Input-C change instruction has yet been received and acted upon). Therefore, the electrophoretic particles 31 and 33 of the corresponding pixel PX in the B and C display areas after the second frame have the same position as shown in the first picture of FIG. 6, and the B and C display areas consecutively display the white image corresponding to the zeroth gray level in the “After 2frame” depiction of FIG. 7.

Next, and focusing for now only on the A display area, after the second frame and before the third frame (the 3Frame of FIG. 5), the signal controller 600 again reads the count-down progress values stored in the second memory 614. Since the A display area stores the 2 horizontal periods, the signal controller 600 again causes the data driver 500 to apply the predetermined positive pixel-drive voltage pulse to the corresponding pixels PX for displaying the “A” glyph in the A display area during the 1 horizontal period of the third frame (the 3Frame of FIG. 5). In this instance, the counter 620 updates the progress value to represent the 1 more needed horizontal period into the A display area of the second memory 614, as shown in FIG. 4. The electrophoretic particles 31 and 33 of the corresponding pixel PX move after the third frame because of application of the positive pixel voltage during the 1 horizontal period of the third frame, as shown in the fourth picture of FIG. 6, and the A display area displays the further darkened character A corresponding to the third gray level.

Referring to FIGS. 4 and 7 for the given example, it is shown here that after the second frame and before the third frame, the signal controller 600 receives a new image changing instruction or signal denoted at “Input B” that instructs the controller 600 to initiate a displaying of the character “B” with the fourth gray level in the B display area of FIG. 7 where the second image changing signal (“Input B”) comes from an external graphic controller (not shown) or an external input device (not shown) and where the content of this second image changing signal (e.g., “Input B”) as well as its time of receipt is controlled by the external device. In response to receipt of this second image changing signal (e.g., “Input B”) at the timing point denoted as “Input B” in FIG. 7, the signal controller 600 stores the desired target value of 4 into the B area of the first memory 612 (see FIG. 4) and it stores the progress count-down value of 4 into the B area of the second memory 614.

That is, in response to receipt of the second image changing signal (e.g., “Input B”) at its corresponding time of receipt, the B display area information storage space of the first memory 612 and the second memory 614 of FIG. 4, corresponding to the B display area of FIG. 7, are respectively caused to store the target value of 4 and the drive time period corresponding to 4 horizontal periods as information on the total time for applying the positive pixel-drive voltage pulse to attain the target optical state in the B display area. It is to be noted with reference to FIG. 5 that if the controller 600 had waited to finish the transition for the “A” area before beginning to change the state of the “B” area, the controller 600 would not begin the changing of the state of the “B” area until after the 4Frame and as a result, the display would exhibit a delay in responding to the real-time provided second image changing signal (e.g., “Input B”). However, in accordance with the present disclosure the controller 600 does not wait and instead it begins the changing of the state of the “B” area as soon as possible (e.g., by applying a state-changing pulse to the B area in the 3Frame of FIG. 5).

After the second image changing signal (e.g., “Input B”) is received at its corresponding time of receipt, the signal controller 600 reads the corresponding input image signal information stored in the B display area information storage space of the second memory 614 (in the After 2Frame state of FIG. 4). Since the B display area information storage space now stores the 4 horizontal periods, which is a non-zero count-down value for corresponding pixels of the B display area, the signal controller 600 applies an output image signal to the data driver 500 so that the data driver 500 may apply a positive pixel voltage pulse to the corresponding pixels PX for beginning to display the “B” character in the B display area in the 3Frame time span of FIG. 5. In this instance, the counter 620 generates the 3 horizontal periods signal, which is the image signal information updated by subtracting the 1 horizontal period from the 4 horizontal periods that is initial count value for the B display area and the updated count value is recorded into the B display area information storage space of the second memory 614, as shown in FIG. 4 at the After 3Frame state. In response to the first drive pulse having been applied to the B display area in the 3Frame time span of FIG. 5, the B display area displays the faint character B corresponding to the first gray level after the third frame (after 3frame in FIG. 7).

Since the “Input C” instruction signal has not yet been received in the after 3frame stage of FIG. 7, the value stored in the C display area information storage space has not yet changed as a result of the events described above. Therefore, the C display area consecutively displays the white image corresponding to the zeroth gray after the third frame in FIG. 7.

Next, after the third frame and before the fourth frame, the “Input C” instruction signal is not yet received as shown in the After 3frame stage of FIG. 4 and the input image signal information stored for area C is not yet updated accordingly. As a result, when the signal controller 600 reads the latest input image signal information stored in the second memory 614 it discovers that the A display area information storage space now stores the progress value equal to 1 horizontal period, and the signal controller 600 accordingly causes the data driver 500 to apply the predetermined positive pixel-drive voltage pulse to the corresponding pixels PX in the A display area during the 1 horizontal period of the 4Frame time span of FIG. 5. In this instance, the counter 620 generates the remaining progress value of 0 horizontal periods for the A display area of the second memory 614, as shown in FIG. 4. The electrophoretic particles 31 and 33 of the corresponding “A” pixels PX have moved as shown in the fifth picture of FIG. 6 after the fourth frame because of application of a positive pixel voltage during the 1 horizontal period of the third frame, and the A display area displays the character A in a darker state that corresponds to the fourth gray level (darkest gray) to be finally displayed as seen in the After 4Frame stage of FIG. 7.

Referring to FIG. 4, recall that the “Input B” signal arrived in the After-2 frame, a first drive pulse to appropriate pixels of area B was applied in the 3Frame time span of FIG. 5 and the counter then reduced the count down for area B from 4 to 3. Accordingly, in the After-3 frame of FIG. 4 the B display area information storage space stores a remaining count of 3 horizontal periods. In response to this nonzero count, the signal controller 600 applies an output image signal to the data driver 500 so that the data driver 500 may apply a positive pixel voltage pulse to the corresponding pixels PX for showing the B in the B display area during the 1 horizontal period of the 4Frame time span of FIG. 5. In this instance, upon application of the drive pulse, the counter 620 generates an updated count representing 2 horizontal periods, which is image signal information newly updated by subtracting the 1 horizontal period from the 3 horizontal periods that was previously the updated image signal information, and this updated count of 2 is automatically stored into the B display area information storage space of the second memory 614, as shown in the After-4 frame stage of FIG. 4. As a result, and referring to FIG. 7, the B display area displays the character B corresponding to the second gray in the After-4 frame stage because of the application of the positive pixel voltage during the 1 horizontal period of the fourth frame.

In addition, since an “Input C” instruction signal had not yet arrived, the value stored in the C display area information storage space is not changed. Therefore, as seen in the After-4 frame stage of FIG. 7, the C display area continues to display the white image that corresponds to the zeroth gray level after the fourth frame.

Next in the given example, after the fourth frame and before the fifth frame, the signal controller 600 finally receives the “Input C” instruction signal that commands it to switch the optical state of area C from the initial target value of 0 to a new target value of 4 for pixels corresponding to the shape of the “C” glyph. In response, the signal controller 600 stores more updated input image information (4,4) in the C region of memory 610 as is reflected in the After-4 frame stage of FIG. 4.

Since in the After-4 frame stage of FIG. 4, the A display area now stores the progress count value of 0 horizontal periods in memory 614, the signal controller 600 prevents the data driver 500 from applying either a positive pixel-drive voltage or a negative pixel-drive voltage to the corresponding pixels PX of the A display area during the 1 horizontal period of the 5Frame time span as shown in FIG. 5. Since progress count down saturates at zero, in this instance, the counter 620 performs no further counting down process since the updated image signal information is the 0 horizontal period, and thus the A display area information storage space is not updated. Accordingly, the A display area continues to display the character A corresponding to the fourth gray after the fifth frame.

Since the B display area information storage space stores the 2 horizontal periods, which is updated image signal information, the signal controller 600 applies an output image signal to the data driver 500 so that the data driver 500 may apply a next positive pixel voltage pulse to the corresponding pixels PX for displaying the B glyph in the B display area during the 1 horizontal period of the fifth frame, as shown in FIG. 5. In this instance, the counter 620 stores the 1 horizontal period, which is image signal information newly updated through the counting and generated by subtracting the 1 horizontal period from the 2 horizontal periods that is previously updated image signal information, into the B display area information storage space of the second memory 614, as shown in FIG. 4. The B display area displays the character B corresponding to the third gray after the fifth frame because of application of a positive pixel voltage during the 1 horizontal period of the fifth frame.

At the start of the fifth frame, the signal controller 600 reads the initial input image signal information stored in the C display control area of the control memory 610. Since the C display area stores the progress value of 4 horizontal periods in memory 614, the signal controller 600 causes the data driver 500 to apply the predetermined positive pixel-drive voltage pulse to the corresponding pixels PX for the C display area during the corresponding 1 horizontal period of the 5Frame time span as shown in FIG. 5. In this instance, the counter 620 updates the progress value and stores the value representing 3 remaining horizontal periods into the C display area of the second memory 614, as shown in FIG. 4. As seen in the after 5Frame stage of FIG. 7, the C display area displays the character C corresponding to the first gray level after the fifth frame because of application of a positive pixel voltage during the 1 horizontal period of the fifth frame.

Next, after the fifth frame and before the sixth frame, the signal controller 600 reads updated input image signal information stored in the second memory 614.

Since the B display area information storage space stores the 1 horizontal period, in the next frame the signal controller 600 causes the data driver 500 to apply the predetermined positive pixel-drive voltage to the corresponding pixels PX in the B display area during the 1 horizontal period of the sixth frame, as shown in FIG. 5. In this instance, the counter 620 updates the progress value and stores the 0 horizontal period indication into the B display area of the second memory 614. The B display area displays the character B corresponding to the fourth gray to be finally displayed after the sixth frame because of application of a positive pixel voltage during the 1 horizontal period of the sixth frame.

Since the C display area information storage space stores the 3 horizontal periods, which is updated image signal information, the signal controller 600 applies an output image signal to the data driver 500 so that the data driver 500 may apply a positive pixel voltage to the corresponding pixels PX for displaying the C in the C display area during the 1 horizontal period of the sixth frame, as shown in FIG. 5. In this instance, the counter 620 stores the 2 horizontal periods, which is image signal information newly updated through the counting and generated by subtracting the 1 horizontal period from the 3 horizontal periods that is previously updated image signal information, into the C display area information storage space of the second memory 614, as shown in FIG. 4. The C display area displays the character C corresponding to the second gray after the sixth frame because of application of a positive pixel voltage during the 1 horizontal period of the sixth frame.

Next, after the sixth frame and before the seventh frame, the signal controller 600 reads updated input image signal information stored in the second memory 614.

Since the A and B display area information storage spaces respectively store progress counts representing 0 horizontal periods, which is image signal information, the signal controller 600 applies an output image control signal to the data driver 500 so that the data driver 500 will not apply a positive pixel voltage or a negative voltage to the corresponding pixels PX but rather a zero voltage (so as to maintain the current optical state) during the 1 horizontal period of the seventh frame, as shown in FIG. 5. Therefore, the A and B display areas respectively continue to display the characters A and B after the seventh frame.

Since the C display area information storage space stores the 2 horizontal periods, which is updated image signal information, the signal controller 600 applies an output image signal to the data driver 500 so that the data driver 500 may apply a positive pixel voltage to the corresponding pixels PX for displaying the C in the C display area during the 1 horizontal period of the seventh frame, as shown in FIG. 5. In this instance, the counter 620 stores the 1 horizontal period, which is image signal information newly updated through the counting and generated by subtracting the 1 horizontal period from the 2 horizontal periods that is previously updated image signal information, into the C display area information storage space of the second memory 614, as shown in FIG. 4. The C display area displays the character C corresponding to the third gray level after the seventh frame because of application of a positive pixel voltage during the 1 horizontal period of the seventh frame.

Next, after the seventh frame and before the eighth frame, the signal controller 600 reads the updated input image signal information stored in the second memory 614.

Since the A and B display area information storage spaces respectively store the 0 horizontal period count, which is image signal information, the signal controller 600 applies an output image control signal to the data driver 500 so that the data driver 500 may not apply a positive pixel voltage to the corresponding pixel PX during the 1 horizontal period of the eighth frame, as shown in FIG. 5. Therefore A and B display areas continue to display the characters A and B corresponding to the fourth gray level after the eighth frame.

Since the C display area information storage space stores the 1 horizontal period, which is updated image signal information, the signal controller 600 applies an output image signal to the data driver 500 so that the data driver 500 may apply a positive pixel voltage to the corresponding pixels PX for displaying the C in the C display area during the 1 horizontal period of the eighth frame, as shown in FIG. 5. In this instance, the counter 620 stores the 0 horizontal period, which is image signal information newly updated through the counting and generated by subtracting the 1 horizontal period from the 1 horizontal period that is previously updated image signal information, into the C display area information storage space of the second memory 614. The C display area displays the character C corresponding to the fourth gray level to be finally displayed after the eighth frame because of application of a positive pixel voltage during the 1 horizontal period of the eighth frame.

Accordingly, the characters A, B, and C corresponding to the fourth (darkest) gray level to be displayed are finally displayed in the A, B, and C display areas after the eighth frame.

Through the performing of the needed updates for each frame in time-overlapping manner over all the pixels by using the above-described method, images with desired gray levels can be displayed in real time response to when the corresponding input command signals (e.g., “Input A”, “Input B”, “Input C”) and in response to their respectively commanded gray levels and glyph defining attributes. Next, when the update of the input image signal information stored in the second memory 614 is finished, the signal controller 600 reads initial input image signal information corresponding to the respective display areas stored in the first memory unit 612. Hence, the signal controller 600 applies an output image compensation signal for eliminating the charges stored in the pixel electrode 190 and the common electrode 270 of the pixel PX to the data driver 500 in the process of applying an output image signal for each display area. The data driver 500 then applies a negative pixel voltage to all the pixels PX. Here, the time for applying the negative pixel voltage controls the 4 horizontal periods of the total 4 frames for the respective A, B, and C display areas to thus perform a compensation process. Therefore, the accumulated charges are eliminated.

As further command inputs arrive, the electrophoretic display repeats the above-noted drive process to display real-time input information to the display areas.

While in the exemplary embodiment, the data driver 500 has applied the positive pixel-drive voltage according to the input of the image signal so as to switch optical states from the all-white reset state to one that has some darkened pixels, it is to be understood that the data driver 500 can apply negative pixel-drive voltages in cases when the electrophoretic particles 31 and 33 are to be moved the opposite direction or in cases where the electrophoretic particles are of opposite charge to the above case.

According to the device and the method for driving the electrophoretic display according to the exemplary embodiment of the present disclosure, the image display speed can be improved by repeatedly applying the image display driving voltage and keeping track of its application time through a real-time update counter to thereby finish the update in the correct number of frames and applying an image display compensation voltage without alternately applying the image display voltage and the image display compensation voltage, differing from the prior art.

Further, power consumption can be reduced by applying no additional nonzero image display drive voltage to those pixels PX that require no further update after per-frame determination that update has been completed.

According to the device and the method for driving the electrophoretic display according to the exemplary embodiment of the present disclosure, the image display speed of the electrophoretic display can be improved and power consumption can be reduced by updating in real-time the information on the time for applying the pixel-drive voltage that is an image display voltage applied to the pixels.

While examples have been described in connection with what is presently considered to be practical, it is to be understood that the disclosure is not limited to the disclosed embodiments, but, on the contrary, is intended to cover various modifications and equivalent arrangements included within the spirit and scope of the disclosure. For example, the progress values in memory 614 can be counted up rather than down until each hits a predetermined cut-off value. For example, the target values stored in memory 612 can be values other than 0 and 4 and they may indicate a magnitude of drive-voltage to be used rather than a target optical state. Additional memory may be provided for storing the previous optical state and the to-be-attained next optical state of each pixel or other display area and the progress value may be used to indicate where in the transition from the original state to the target state the electrophoretic particles currently are. The controller 600 may then use this information to make more intelligent decisions of how to achieve rapid image change in the display.

What is claimed is:

1. A drive controller of an electrophoretic display comprising a data driver for applying drive voltages and compensating voltages to selectable ones of a plurality of pixels each having electrophoretic particles disposed therein, the drive controller comprising:
a memory unit structured to store for each pixel or other predefined display area, a progress value and a drive target value, where the stored progress value indicates an amount of further drive time needed for driving the corresponding pixel or other predefined display area to an optical state corresponding to the drive target value; and
a signal controller operatively coupled to the memory unit for updating at least the progress values of corresponding pixels or other predefined display areas after drive times in which the data driver applied drive voltages to the corresponding pixels or other predefined display areas so as to move them progressively towards the respective optical states indicated by the corresponding drive target values;
wherein upon the progress value of a given pixel or other predefined display area indicating that the corresponding optical target state has been reached, the drive controller causes a compensating voltage to be applied to the given pixel or other predefined display area so as to return to its original optical state.

2. The drive controller of claim 1, wherein the memory unit includes a first memory storing the drive target value of each pixel or other predefined display area and a second memory storing the progress value of each pixel or other predefined display area.

3. The drive controller of claim 2, wherein for each of successive frames the drive controller reads the progress value of each pixel or other predefined display area from the second memory in order to determine whether or not to continue applying state-altering drive voltages to said each pixel or to predetermined pixels of the predefined display areas, and if yes, the drive controller updates the respectively read progress values to reflect the continued application of the state-altering drive voltages to the respective each pixel or to predetermined pixels of the predefined display areas, while if no, the drive controller causes the compensating voltage to be applied to the respective each pixel or the predetermined pixels of the predefined display areas.

4. The drive controller of claim 3, wherein the progress value represents a time remaining for applying a corresponding state-altering drive voltage to the respective each pixel or to predetermined pixels of the predefined display areas so as to thereby drive electrophoretic particles towards an optical state corresponding to supplied luminance information.

5. The drive controller of claim 4, wherein the signal controller further includes a counter performing counting in each of successive frames so as to update the progress value of each pixel or other predefined display area in the second memory.

6. The drive controller of claim 5, wherein the time for applying the state-altering drive voltage is 1 horizontal period per frame.

7. The drive controller of claim 6, wherein the electrophoretic particles include first electrophoretic particles and second electrophoretic particles having opposite charges.

8. A method for driving an electrophoretic display comprising a data driver for applying an image data signal to a plurality of pixels to which electrophoretic particles are provided, the method comprising:
storing initial input image signal information or input image signal information that is updated through counting performed for a predetermined time into a memory unit;
outputting an output image signal to the data driver according to the initial input image signal information or the updated input image signal information stored in the memory unit, and storing the input image signal information updated through counting into the memory unit; and
applying an output image compensation signal to the data driver according to the initial input image signal information stored in the memory unit when the update on the input image signal information stored in the memory unit is finished.

9. The method of claim 8, wherein in the step of storing the initial input image signal information or the input image signal information updated through counting for each predetermined time into a memory unit, the memory unit includes a first memory for storing the initial input image signal information and a second memory for storing the initial input image signal information or the updated input image signal information.

10. The method of claim 9, wherein in the step of outputting an output image signal to the data driver according to the initial input image signal information or the updated input image signal information stored in the memory unit and storing the input image signal information updated through counting into the memory unit, an output image signal is output to the data driver based on the initial input image signal information or the updated input image signal information stored in the second memory, and the input image signal information updated through counting is stored in the second memory.

11. The method of claim 10, wherein the input image signal information is information on the time for applying a pixel voltage applied so as to drive the electrophoretic particles as luminance information displayed by the plurality of pixels.

12. The method of claim 11, wherein the counting is performed per frame.

13. The method of claim 12, wherein the time for applying the pixel voltage is the 1 horizontal period per frame, and the input image signal information updated through the counting is information on the time for applying the pixel voltage that is reduced by the 1 horizontal period before performing the counting.

14. The method of claim 13, wherein the electrophoretic particles include first electrophoretic particles and second electrophoretic particles having opposite polarities.

15. The method of claim 8, before the step of storing the initial input image signal information or the input image signal information that is updated through counting performed for a predetermined time into a memory unit, further including,
applying a reset image signal to the data driver, and
applying a reset image compensation signal to the data driver.

16. A method of responding in real time to input command signals that command a driving of one or more electrophoretic display cells towards a commanded optical state, the method comprising:
in response to receipt of one or more of said input command signals, automatically recording in memory a target indicator that indicates an optical state that is to be achieved for a corresponding pixel or a corresponding group of pixels and a progress indicator that indicates how many steps and/or how much time remains for achieving the indicated optical state; and
for each allowed time span where the corresponding pixel or corresponding group of pixels can be driven to their respective indicated optical states, applying a state-altering drive signal to the corresponding electrophoretic display cell or cells and updating the corresponding progress indicator or indicators to indicate how many further steps, if any, and/or how much further time, if any, remains for achieving the indicated optical state.
